(19) United States
(12) Patent Application Publication
(10) Pub. No.: US 2025/0158160 A1
(43) Pub. Date: May 15, 2025

(54) SYSTEMS FOR A BATTERY

(71) Applicant: Dana Canada Corporation, Oakville (CA)

(72) Inventors: Ihab Edward GERGES, Oakville (CA); Lee M. KINDER, Oakville (CA)

(21) Appl. No.: 18/507,754

(22) Filed: Nov. 13, 2023

(51) Int. Cl. H01M 10/6557; H01M 10/625; H01M 10/6567; H01M 50/204; H01M 50/249; H01M 50/507

(52) U.S. Cl. CPC H01M 10/6557; H01M 10/625; H01M 10/6567; H01M 50/204; H01M 50/249; H01M 50/507; H01M 2220/20

(57) ABSTRACT

Systems are provided for a battery. In one example, the battery includes a plurality of battery cells and a plurality of heat exchangers of a thermal management system. The plurality of heat exchangers comprise a plurality of spray ports configured to spray fluid onto the plurality of battery cells and other electronics in a housing of the battery.

### TECHNICAL FIELD

The present description relates generally to systems for a battery of a vehicle.

### BACKGROUND AND SUMMARY

Vehicles may be equipped with electrical energy storage devices. The energy storage devices may be configured to discharge electrical energy to operate an electric motor and receive electrical energy to restore a vehicle range. Some customers may be reluctant to transition to electrified vehicles due to certain drawbacks.

For example, the ubiquity of fuel stations and speed of refueling an internal combustion engine vehicle with fuel may present an increased convenience relative to recharging an electric vehicle. Electric vehicle recharging stations may be less common in less populated areas and recharging rates may be relatively long compared to refueling rates. Thus, methods and systems different than those that already exist may be desired.

It may be desired to provide thermal management systems that enhance battery temperature control to increase recharge rate. In one example, the issues described above may be addressed by a battery including a housing. A plurality of battery cells is arranged within the housing along with a plurality of heat exchangers positioned between the plurality of battery cells. The plurality of heat exchangers comprises a plurality of spray ports. In this way, the spray ports may provide enhanced thermal management of the plurality of battery cells.

As one example, the plurality of heat exchangers may be included in an immersion thermal management system. The plurality of spray ports may be positioned above the plurality of battery cells. Fluid may be sprayed from the plurality of spray ports on the plurality of battery cells and other electronics within the housing. The plurality of heat exchangers may be positioned such that at least one side of each heat exchanger is in face-sharing contact with at least one side of a battery cell of the plurality of battery cells. By doing this, thermal effects due to elevated temperatures may be mitigated via the plurality of heat exchangers.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a vehicle at least partially driven via an electric motor.

FIG. 2 shows a first view of an interior volume of a battery enclosure.

FIG. 3 shows a second view of the battery enclosure.

FIG. 4 shows a third view of the interior volume of the battery enclosure.

FIG. 5 shows a fourth view of the interior volume of the battery enclosure.

### DETAILED DESCRIPTION

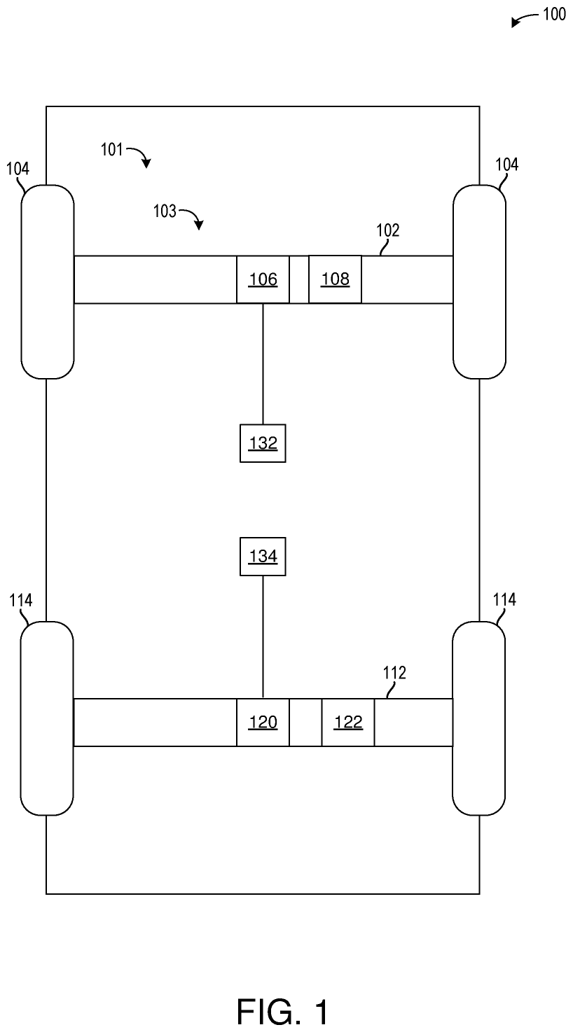

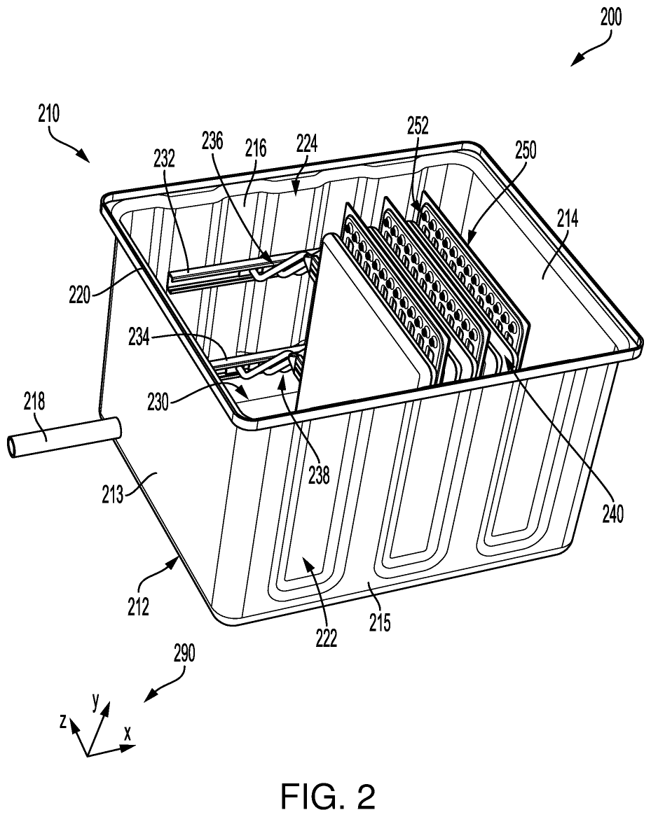

The following description relates to systems for a battery. The battery may include cells and electrical connections associated with electrical energy being stored or transferred. The battery may include or be coupled to a thermal management system. The battery may be coupled to an electric motor of a vehicle, as shown in FIG. 1. The battery may include a battery housing (interchangeably referred to herein as a battery enclosure). The battery housing may include an interior volume in which a plurality of battery cells and heat exchangers are arranged, as shown in FIGS. 2, 4, and 5. An exterior of the battery housing may include one or more ports for circulating fluid in and out of the interior volume of the battery enclosure.

FIGS. 1-5 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 2-5 are drawn approximately to scale. Other dimensions may be used if desired.

Turning now to FIG. 1, a vehicle 100 is shown comprising a powertrain 101 and a drivetrain 103. The powertrain 101 may comprise a prime mover 106 and a transmission 108. The prime mover 106 may be an electric motor, for example, and is operated to provide rotary power to the transmission 108. The transmission 108 may be any type of transmission, such as a manual transmission, an automatic transmission, or a continuously variable transmission. Herein, the transmission 108 may be interchangeably referred to as a gearbox. The transmission 108 receives the rotary power produced by the prime mover 106 as an input and outputs rotary power to a first axle assembly 102 in accordance with a selected gear or setting. In one example, the prime mover 106 is one of a plurality of prime movers, wherein each of the plurality of prime movers may include various powertrain components for supplying power to a first set of wheels 104 and/or other components of the vehicle 100.

The prime mover 106 may be powered via energy from an energy storage device 132. In one example, the energy storage device 132 is a battery configured to store electrical energy. An inverter may be arranged between the energy storage device 132 and the prime mover 106 and may be configured to adjust direct current (DC) to alternating current (AC). The inverter may include a variety of components and circuitry with thermal demands that effect an efficiency of the inverter.

In some examples, the transmission may be omitted and the prime mover may be one of a plurality of prime movers positioned adjacent to a corresponding wheel.

The vehicle 100 may be one or more of a commercial vehicle, light, medium, or heavy duty vehicle, a passenger vehicle, an off-highway vehicle, and sport utility vehicle. Additionally or alternatively, the vehicle 100 and/or one or more of its components may be in industrial, locomotive, military, agricultural, and aerospace applications. In one example, the vehicle 100 is an all-electric vehicle or a vehicle with all-electric modes of operation, such as a plug-in hybrid vehicle. As such, the prime mover 106 is an electric machine. In one example, the prime mover 106 is an electric motor/generator.

In some examples, such as shown in FIG. 1, the drivetrain 103 includes the first axle assembly 102 and a second axle assembly 112. The first axle assembly 102 may be configured to drive the first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In the illustrated example, the powertrain 101 includes a prime mover 120 and a transmission 122. The prime mover 120 may be an internal combustion engine (ICE) or an electric motor, for example, and is operated to provide rotary power to the transmission 122. The transmission 122 may be any type of transmission, such as a manual transmission, an automatic transmission, or a continuously variable transmission. Herein, the transmission 122 may be interchangeably referred to as a gearbox. The transmission 122 receives the rotary power produced by the prime mover 120 as an input and outputs rotary power to the second axle assembly 112 in accordance with a selected gear or setting. In one example, the prime mover 120 is one of a plurality of prime movers, wherein each of the prime movers may include various powertrain components for supplying power to the second set of wheels 114 and/or other components of the vehicle 100.

The prime mover 120 may be powered via energy from an energy storage device 134. In one example, the energy storage device 134 is a battery configured to store electrical energy. An inverter may be arranged between the energy storage device 134 and the prime mover 120 and may be configured to adjust direct current (DC) to alternating current (AC). The inverter may include a variety of components and circuitry with thermal demands affecting an efficiency of the inverter.

In some examples, additionally or alternatively, the vehicle 100 may be a hybrid vehicle including both an engine and an electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly configured to be driven by an integrated electric machine.

In some embodiments, additionally or alternatively, the energy storage device and the electric machine may be used in stationary applications. That is to say, the energy storage device and the electric machine may be used for actuating a tool or other device and not used for propulsion in some applications without departing from the scope of the present disclosure.

Turning now to FIG. 2, it shows a first view 200 of a battery system including a housing 212 for a battery 210. The battery 210 may be a non-limiting example of energy storage device 132 and/or energy storage device 134 of FIG. 1. An axis system 290 is shown comprising three axes, namely an x-axis parallel to a longitudinal direction, a y-axis parallel to a vertical direction, and a z-axis parallel to a lateral direction. A direction of gravity may be parallel to the y-axis.

The housing 212 may include a plurality of sides that form at least a portion of a box. In one example, the box is a rectangular prism. In some embodiments, additionally or alternatively, the box may include other shapes, such as a cube shape. The plurality of sides may include a first short side 213, a second short side 214, a first long side 215, and a second long side 216. The first short side 213 and the second short side 214 may be identical to one another in size and shape. The first short side 213 and the second short side 214 may be arranged opposite and spaced away from one another. The first long side 215 and the second long side 216 may be identical to one another in size and shape. The first long side 215 and the second long side 216 may be arranged opposite and spaced away from one another. In one example, the first long side 215 is physically coupled to the first short side 213 at a first extreme end and to the second short side 214 at a second extreme end, opposite to the first extreme end. The second long side 216 is physically coupled to the first short side 213 at a first extreme end and to the second short side 214 at a second extreme end, opposite to the first extreme end.

A conduit 218 may extend from the first short side 213. The conduit 218 may be a fluid conduit configured to circulate fluid to or from an interior volume 230 of the housing 212. In this way, the conduit 218 may extend through a thickness of the first short side 213 and fluidly couple the interior volume 230 to another component, such as a radiator, a heat exchanger, a pump, or other device included in a fluid circuit, arranged outside of the housing 212. In one example, the conduit 218 is an outlet.

A plurality of ribs 222, 224 may be arranged on the first long side 215 and the second long side 216. The first long side 215 may include a first plurality of ribs 222 and the second long side 216 may include a second plurality of ribs 224. The first and second plurality of ribs 222, 224 may be identical to one another and may extend in a vertical direction parallel to the y-axis. A strength of the housing 212 may be increased via the first and second plurality of ribs 222, 224. Additionally or alternatively, a surface area of the housing 212 is increased via the first and second plurality of ribs 222, 224. As such, a fluid temperature in the interior volume 230 may be reduced via increased thermal communication between surfaces of the housing 212 and ambient. In this way, the first long side 215 and the second long side 216 may include features that deviate from planar while the first short side 213 and the second short side 214 are planar. The first long side 215 and the second long side 216 are parallel to an x-y plane. The first short side 213 and the second short side 214 are parallel to a z-y plane, which is normal to the x-y plane.

In one example, a shape of the housing 212 and a number of the plurality of ribs 222, 224 may be adjusted based on an application in which the battery 210 is included. In some embodiments, the plurality of ribs 222, 224 may be omitted. Additionally or alternatively, a shape of the housing 212 may deviate from rectangular or square.

A lip 220 may be extend around a top of each of the first short side 213, the second short side 214, the first long side 215, and the second long side 216. The lip 220 may be a continuous component comprising a perimeter greater than a perimeter of the plurality of sides of the housing 212. That is to say, the lip 220 may extend beyond a profile of each of the plurality of sides in the x-z plane, normal to gravity. The lip 220 may further extend along the y-axis. In this way, a cross-sectional shape of the lip 220 may be an L-shape. Said another way, the lip 220 may include an elbow, wherein the lip 220 extends outward from plurality of sides and then upward in a direction parallel to the plurality of sides.

A cover may be arranged along an interior of the lip 220. The cover may include hooks, latches, or other coupling devices that engage with an exterior of the lip 220. For example, the latches may wrap around the elbow of the lip 220 and engage with surfaces of the lip 220 in the x-z plane. Additionally or alternatively, the cover may be physically coupled to the lip 220 via welds, fusions, adhesives, and/or fasteners.

In one example, the housing 212, including the plurality of sides and the lip 220, is a single, continuous piece. The housing 212 may be manufactured via a mold. The housing 212 may comprise one or more of plastic, metal, silicon, ceramic, or other materials.

The interior volume 230 may include a first bus bar 232 and a second bus bar 234. In the example of FIG. 2, the first bus bar 232 and the second bus bar 234 are mounted to the second long side 216. In some examples, additionally or alternatively, the first bus bar 232 and the second bus bar 234 may be mounted to a different side. Additionally or alternatively, the first bus bar 232 and the second bus bar 234 may be not be mounted to the same side as one another.

The first bus bar 232 may be a positive bus bar and the second bus bar 234 may be a negative bus bar. A plurality of first lead lines 236 may extend from a plurality of battery cells 240 to the first bus bar 232. A plurality of second lead lines 238 may extend from the plurality of battery cells 240 to the second bus bar 234. The first bus bar 232 and the second bus bar 234 may be located in other positions without departing from the scope of the present disclosure.

The plurality of battery cells 240 may be arranged such that each cell is parallel to a y-z plane. One of the plurality of first lead lines 236 and one of the plurality of second lead lines 238 may extend from a battery cell of the plurality of battery cells 240. Thus, if there are 5 of the plurality of battery cells 240, then there may be 5 of the plurality of first lead lines 236 and 5 of the plurality of second lead lines 238. In some examples, the lead lines may be omitted and cell terminals may couple directly onto the bus bars.

The plurality of battery cells 240 may be supported by a plurality of heat exchangers 250. In one example, the plurality of heat exchangers 250 are intercell (IC) heat exchangers. As such, a heat exchanger of the plurality of heat exchangers 250 may be arranged between every other cell of the plurality of battery cells 240. Additionally or alternatively, the heat exchanger of the plurality of heat exchangers 250 may be arranged on each side of a cell of the plurality of battery cells 240. By doing this, a deformation of the plurality of battery cells 240 may be reduced. For example, swelling of the plurality of battery cells 240 may be reduced, which may allow faster charging rates and increase a rate of electric vehicle proliferation.

In one example, at least one side of each of the plurality of battery cells 240 may be in face-sharing contact with at least one side of each of the plurality of heat exchangers 250. For example, two or more of the plurality of heat exchangers 250 may be sandwiched by battery cells of the plurality of battery cells 240.

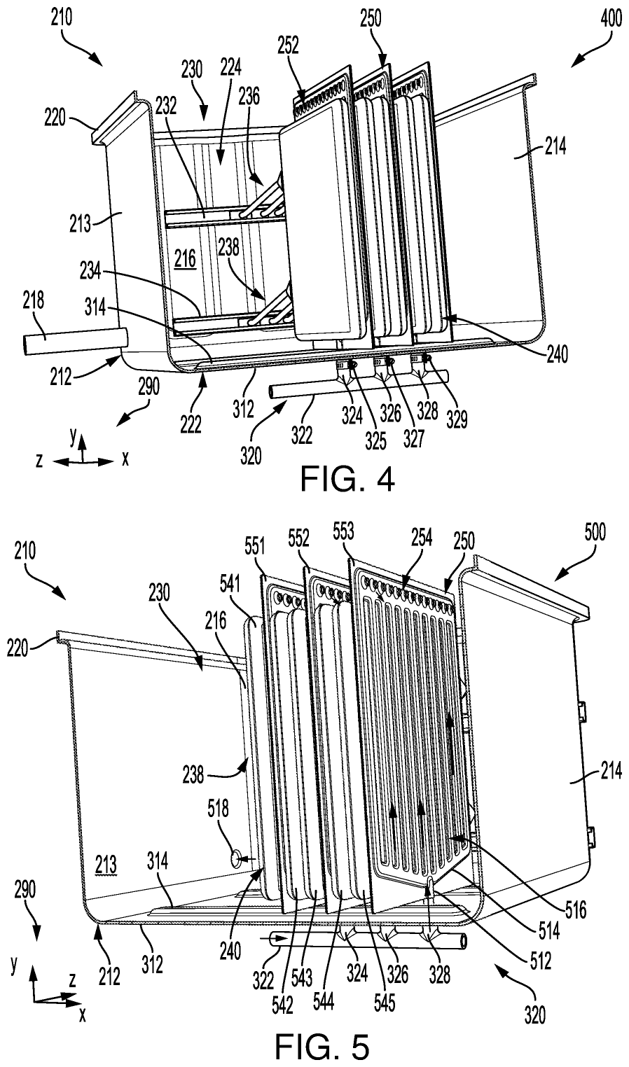

Each of the plurality of heat exchangers 250 may include a plurality of spray ports 252 arranged outside of a profile of each of the plurality of battery cells 240. In one example, the plurality of spray ports 252 may be vertically higher than the plurality of battery cells 240. The plurality of spray ports 252 may be configured to direct fluid to one or more of the first bus bar 232, the second bus bar 234, the plurality of first lead lines 236, the plurality of second lead lines 238, connections between the bus bars, the lead lines, and the plurality of battery cells 240, and to additional portions of the plurality of battery cells 240, such as a top of a battery cell. The plurality of spray ports 252 and the plurality of heat exchangers 250 are described in greater detail with respect to FIGS. 4 and 5.

In this way, the plurality of heat exchangers 250 provide structural support to the plurality of battery cells 240 and provide thermal management utilizing fluid immersion, intercell face-to-face contact, and fluid spray. As such, a spray system is integrally arranged in the plurality of heat exchangers 250 and a separate spray system is omitted, thereby decreasing manufacturing costs and complexity, which enhances thermal management of the plurality of battery cells 240.

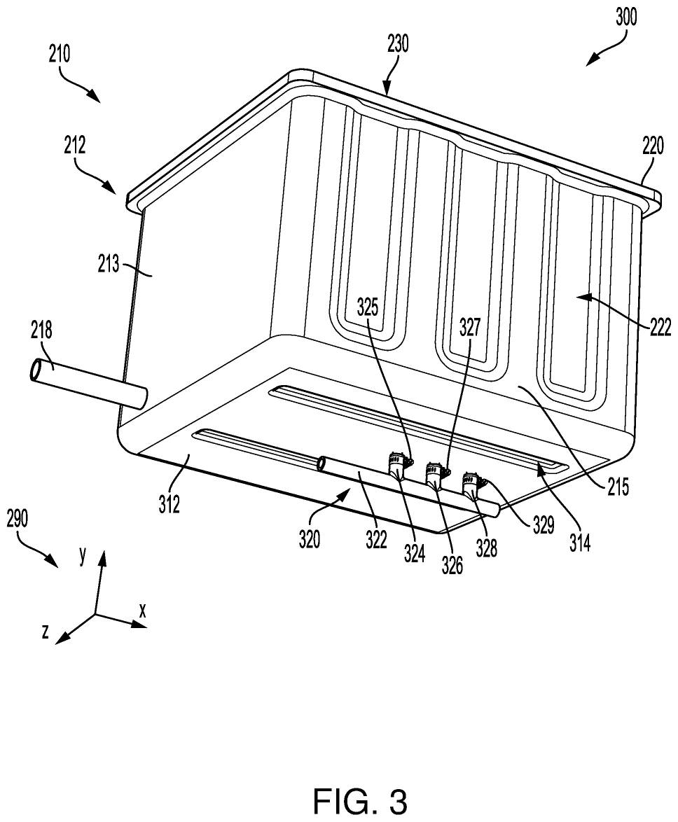

Turning now to FIG. 3, it shows a second view 300 of the housing 212 of the battery 210. As such, components previously introduced are similarly numbered in this and subsequent figures. The second view 300 illustrates a bottom 312 of the housing 212. The bottom 312 may be coupled to each of the plurality of sides including the first short side 213, the second short side (e.g., the second short side 214 of FIG. 2), the first long side 215, and the second long side (e.g., the second long side 216 of FIG. 2). The bottom 312 may be parallel to the x-z plane. The bottom 312 may be physically coupled to an edge of the plurality of sides opposite to an edge to which the lip 220 is physically coupled.

The bottom 312 may include a plurality of ribs 314. The plurality of ribs 314 may be similar in shape to the first plurality of ribs 222 or the second plurality of ribs 224. The plurality of ribs 314 may extend in a direction normal to a direction of the first plurality of ribs 222. In one example, the plurality of ribs 314 may extend in a direction along the x-z plane.

An inlet manifold 320 may be coupled to the bottom 312. The inlet manifold 320 may include a conduit 322 that is fluidly coupled to a plurality of passages. In one example, the conduit 322 is an inlet conduit and the conduit 218 is an outlet conduit. A number of the plurality of passages may be equal to a number of the plurality of heat exchangers (e.g., the plurality of heat exchangers 250) arranged within the housing 212. The plurality of passages may include a first passage 324, a second passage 326, and a third passage 328. Each of the first passage 324, the second passage 326 and the third passage 328 may extend through a thickness of the bottom 312 and directly fluidly couple with a corresponding heat exchanger of the plurality of heat exchangers. It will be appreciated that the inlet manifold 320 and the conduit 218 may be located in other locations without departing from the scope of the present disclosure.

The first passage 324 may include a first hose clamp 325. The second passage 326 may include a second hose clamp 327. The third passage 328 may include a third hose clamp 329.

Each of the plurality of passages may include a valve for controlling fluid flow to the corresponding heat exchanger. A position of the valve may be adjusted in response to a battery cell temperature, a bus bar temperature, a lead line temperature, or the like. The valve may be actuated to a fully open position (e.g., 100% open), a fully closed position (e.g., 0% open), or a plurality of positions therebetween. Additionally or alternatively, a single valve may control coolant flow from the inlet manifold 320 to the plurality of heat exchangers.

In some embodiments of the inlet manifold 320, a single conduit may extend toward the housing 212, wherein the plurality of passages may be arranged within the interior volume of the housing 212. As such, the single conduit may branch to the plurality of heat exchangers within the interior volume 230.

The conduit 322 and the conduit 218 may extend in identical direction. In one example, the conduit 322 and the conduit 218 are parallel to the x-axis. The conduit 322 and the conduit 218 may be configured to circulate fluid through the interior volume of the housing 212. In one example, the fluid is a dielectric fluid.

Turning now to FIGS. 4 and 5, they show fourth and fifth views 400 and 500, respectively, of the housing 212 of the battery 210. The fourth view 400 and the fifth view 500 illustrates a more detailed relationship between the plurality of battery cells 240 and the plurality of heat exchangers 250. FIGS. 4 and 5 are described in tandem herein.

In the examples of FIGS. 4 and 5, the plurality of spray ports 252 are a first plurality of spray ports 252. The first plurality of spray ports 252 are arranged on a first side of the plurality of heat exchangers 250, wherein the first side faces the first short side 213. The plurality of heat exchangers 250 may further include a second plurality of spray ports 254. The second plurality of spray ports 254 may be arranged on a second side of the plurality of heat exchangers 250. The second side of the plurality of heat exchangers 250 may be opposite the first side and face the second short side 214. In one example, the first side of a heat exchanger is in face-sharing contact with one battery cell and the second side of the heat exchanger is in face-sharing contact with a different battery cell.

In some examples, one or more heat exchangers of the plurality of heat exchangers 250 may be free of spray ports. That is to say, spray ports may not be arranged on both sides of one or more heat exchangers. Fluid flow may be directed to regions free of spray ports. Additionally or alternatively, one or more of the plurality of heat exchangers 250 may include spray ports on only a single side, wherein the other side is free of spray ports. That is to say, one or more of the plurality of heat exchangers 250 comprises only the first plurality of spray ports or only the second plurality of spray ports

Each of the first plurality of spray ports 252 and the second plurality of spray ports 254 may be configured to spray fluid downward toward the bus bars, lead lines, and battery cells. In one example, the first plurality of spray ports 252 and the second plurality of spray ports 254 may be arranged near a top of the plurality of heat exchangers 250, wherein the top may be positioned vertically higher than (e.g., above) a height of the plurality of battery cells 240. Additionally or alternatively, a height of the plurality of heat exchangers 250 may be greater than a height of the housing 212, wherein the height is measured along the y-axis. In one example, the height of the housing 212 includes a height of the walls and a height of the lip 220. A lid of the housing 212 may thus be shaped to hermetically seal the interior volume 230 of the housing 212 while still containing the plurality of heat exchangers 250 within the interior volume 230.

In the examples of FIGS. 4 and 5, an arrangement of the plurality of battery cells 240 and the plurality of heat exchangers 250 includes where a first battery cell 541 is positioned nearest to the first short side 213. A first heat exchanger 551 may be positioned between the first battery cell 541 and a second battery cell 542. The second battery cell 542 may be adjacent to a third battery cell 543 without a heat exchanger arranged therebetween. In some examples, additionally or alternatively, a heat exchanger may be arranged between the second battery cell 542 and the third battery cell 543. A second heat exchanger 552 may be arranged between the third battery cell 543 and a fourth battery cell 544. The fourth battery cell 544 is adjacent to a fifth battery cell 545, wherein a heat exchanger is not arranged between the fourth battery cell 544 and the fifth battery cell 545. A third heat exchanger 553 may be arranged between the fifth battery cell 545 and the second short side 214. In one example, a distance between the third heat exchanger 553 and the second short side 214 is less than a distance between the first battery cell 541 and the first short side 213. Additionally or alternatively, the arrangement of the battery cells and the heat exchangers may be equidistant to the first short side 213 and the second short side 214 or biased toward the first short side 213. In this way, a symmetric or asymmetric configuration may be utilized without departing from the scope of the disclosure.

In one example, the examples of FIGS. 4 and 5 omit battery cells and heat exchangers to provide a more detailed view of the interior volume of the housing. In some examples, the interior volume may include a number of battery cells and heat exchangers that reduces an amount of vacant space available and maximizes energy storage and thermal management.

Arrows illustrates a direction of fluid flow through the inlet manifold 320, the plurality of heat exchangers 250, the interior volume 230, and the conduit 218. Fluid flows through the conduit 322 to each of the first passage 324, the second passage 326, and the third passage 328. Fluid may then flow through the passages and through the bottom 312 to the plurality of heat exchangers 250. Fluid flows from the first passage 324 to the first heat exchanger 551. Fluid flows from the second passage 326 to the second heat exchanger 552. Fluid flow from the third passage 328 to the third heat exchanger 553. Fluid entering the plurality of heat exchangers 250 from the passages may flow through a heat exchanger inlet region 512. The heat exchanger inlet region 512 may direct fluid to a heat exchanger manifold 514. The heat exchanger manifold 514 may include a plurality of ribs 516. The plurality of ribs 516 may shape a plurality of passages that are parallel to the y-z plane. The plurality of ribs 516 may increase a surface area of the heat exchanger, which may promote increased temperature control of the plurality of battery cells 240. The plurality of ribs 516 may additionally provide structural support to the plurality of battery cells 240 and/or a corresponding heat exchanger. In one example, the plurality of ribs 516 are linear and parallel to the y-axis. The plurality of ribs 516 may be arranged on both sides of each heat exchanger such that the plurality of ribs face the first short side 213 and the second short side 214. A height of plurality of ribs 516, measured along the y-axis, may be non-uniform. In one example, ribs closer to the heat exchanger inlet region 512 may include a height greater than ribs further from the heat exchanger inlet region 512. The height, width, and dimensions of the plurality of ribs 516 may be adjusted without departing from the scope of the present disclosure.

In some embodiments, additionally or alternatively, the plurality of ribs 516 may be omitted and the plurality of heat exchangers 250 may include dimples, protrusions, or other patterns that alter a surface area and fluid flow pattern. In some examples, the plurality of ribs 516 may include a combination of ribs, dimples, protrusions, and the like. Additionally or alternatively, the plurality of heat exchangers 250 may include internal components, such as turbulators, in conjunction with outer plates where a heat transfer area is not present.

Fluid may flow up the plurality of passages to the first plurality of spray ports 252 and the second plurality of spray ports 254. The first plurality of spray ports 252 may spray fluid at a first angle and the second plurality of spray ports 254 may spray fluid at a second angle, different than the first angle. In one example, the first angle is different than the second angle by at least 45 degrees, or at least 90 degrees, or at least 135 degrees, or at least 180 degrees. In some examples, additionally or alternatively, ports of the first plurality of spray ports 252 and/or the second plurality of spray ports 254 may be angled differently relative to one another. Additionally, a spray direction of each port of the first plurality of spray ports 252 and/or the second plurality of spray ports 254 may be oriented differently. For example, some spray ports may spray onto the battery cells and other spray ports may spray onto the bus bar. As another examples, Orientations of each of a plurality of spray ports arranged on a common side may be uniform (e.g., identical).

In one example, the first plurality of spray ports 252 and the second plurality of spray ports 254 may be arranged on faces of the plurality of heat exchangers 250. A direction of the spray ports may be directed toward different walls of the housing 212 based on demands of the application. In the examples of FIGS. 4 and 5, the spray ports are directed toward the first short side 213 and the second short side 214. In other examples, the plurality of heat exchangers 250 may be oriented such that the plurality of spray ports is oriented toward the first long side 215 and the second long side 216.

Fluid may exit the interior volume 230 via flowing through opening 518 and entering the conduit 218. The opening 518 is arranged in the first short side 213 and fluidly couples the conduit 218 to the interior volume. In this way, the conduit 218 and the conduit 322 promote fluid circulation through the interior volume 230 of the housing 212. While the inlet manifold 320 and the conduit 218 are shown as being coupled to different surfaces of the housing 212, in some embodiments, the inlet manifold 320 and the conduit 218 may be coupled to the same surface without departing from the scope of the disclosure.

In this way, a battery comprising an immersion thermal management system further includes heat exchangers positioned between battery cells. The spray ports of the heat exchangers may reduce thermal stresses experienced by the battery cells. By doing this, a charge rate of the battery cells may be increased, which may increase customer satisfaction and electric vehicle adoption.

The disclosure provides support for a battery including a housing, a plurality of battery cells arranged within the housing, and a plurality of heat exchangers positioned between the plurality of battery cells, the plurality of heat exchangers comprising a plurality of spray ports. A first example of the battery further includes where the plurality of spray ports is a first plurality of spray ports arranged on a first side of the plurality of heat exchangers, further comprising a second plurality of spray ports arranged on a second side of the plurality of heat exchangers, the second side opposite the first side. A second example of the battery, optionally including the first example, further includes where an inlet manifold comprising a conduit fluidly coupled to a plurality of passages. A third example of the battery, optionally including one or more of the previous examples, further includes where each of the plurality of passages is fluidly coupled to one of the plurality of heat exchangers. A fourth example of the battery, optionally including one or more of the previous examples, further includes an outlet conduit arranged in a wall of the housing different than a wall to which the inlet manifold is coupled. A fifth example of the battery, optionally including one or more of the previous examples, further includes where the plurality of spray ports is configured to spray fluid toward one or more of the plurality of battery cells, one or more bus bars, and one or more lead lines arranged between the plurality of battery cells and the one or more bus bars. A sixth example of the battery, optionally including one or more of the previous examples, further includes where the plurality of heat exchangers supports the plurality of battery cells in the housing.

The disclosure provides additional support for a system including a battery comprising a housing, a plurality of battery cells arranged within the housing, and a thermal management system comprising a plurality of heat exchangers arranged between the plurality of battery cells, wherein one or more of the plurality of heat exchangers comprises a first plurality of spray ports on a first side and a second plurality of spray ports on a second side opposite to the first side. A first example of the system further includes where each of the plurality of heat exchangers comprises a heat exchanger inlet region fluidly coupled to a plurality of heat exchanger passages shaped via a plurality of ribs, wherein each of the plurality of heat exchanger passages is fluidly coupled to a spray port of one or more of the first plurality of spray ports and the second plurality of spray ports. A second example of the system, optionally including the first example, further includes where a height of the plurality of heat exchanger passages is non-uniform. A third example of the system, optionally including one or more of the previous examples, further includes where one or more of the plurality of heat exchangers comprises only the first plurality of spray ports or only the second plurality of spray ports. A fourth example of the system, optionally including one or more of the previous examples, further includes where the plurality of heat exchangers is parallel to the plurality of battery cells. A fifth example of the system, optionally including one or more of the previous examples, further includes where the first plurality of spray ports and the second plurality of spray ports are positioned vertically above the plurality of battery cells. A sixth example of the system, optionally including one or more of the previous examples, further includes where the thermal management system is an immersion thermal management system. A seventh example of the system, optionally including one or more of the previous examples, further includes where an inlet manifold configured to flow fluid into an interior volume of the housing and a conduit is configured to flow fluid out of the interior volume.

The disclosure provides further support for a battery system including a plurality of battery cells arranged within a housing, a plurality of bus bars mounted to a wall of the housing, a plurality of lead lines coupled to the plurality of battery cells and the plurality of bus bars, and a plurality of heat exchangers arranged with the housing, the plurality of heat exchangers comprising a plurality of spray ports configured to spray fluid onto the plurality of battery cells. A first example of the battery system further includes where each of the plurality of battery cells is in face-sharing contact along at least a face of a battery cell with a heat exchanger of the plurality of heat exchangers. A second example of the battery system, optionally including the first example, further includes where a height of each of the plurality of heat exchangers is greater than a height of sides of the housing, and wherein the plurality of spray ports is positioned vertically above the plurality of battery cells. A third example of the battery system, optionally including one or more of the previous examples, further includes where an inlet manifold comprising a conduit fluidly coupled to a plurality of passages, each of the plurality of passages fluidly coupled to a heat exchanger inlet region of each of the plurality of heat exchangers, each of the plurality of heat exchangers comprising a plurality of ribs and a plurality of heat exchanger passages extending from the heat exchanger inlet region to the plurality of spray ports. A fourth example of the battery system, optionally including one or more of the previous examples, further includes where two or more of the plurality of heat exchangers are sandwiched by two of the plurality of battery cells.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery, comprising:
a housing;
a plurality of battery cells arranged within the housing; and
a plurality of heat exchangers positioned between the plurality of battery cells, the plurality of heat exchangers comprising a plurality of spray ports.

2. The battery of claim 1, wherein the plurality of spray ports is a first plurality of spray ports arranged on a first side of the plurality of heat exchangers, further comprising a second plurality of spray ports arranged on a second side of the plurality of heat exchangers, the second side opposite the first side.

3. The battery of claim 1, further comprising an inlet manifold comprising a conduit fluidly coupled to a plurality of passages.

4. The battery of claim 3, wherein each of the plurality of passages is fluidly coupled to one of the plurality of heat exchangers.

5. The battery of claim 3, further comprising an outlet conduit arranged in a wall of the housing different than a wall to which the inlet manifold is coupled.

6. The battery of claim 1, wherein the plurality of spray ports is configured to spray fluid toward one or more of the plurality of battery cells, one or more bus bars, and one or more lead lines arranged between the plurality of battery cells and the one or more bus bars.

7. The battery of claim 1, wherein the plurality of heat exchangers supports the plurality of battery cells in the housing.

8. A system, comprising:
a battery comprising a housing;
a plurality of battery cells arranged within the housing; and
a thermal management system comprising a plurality of heat exchangers arranged between the plurality of battery cells, wherein one or more of the plurality of heat exchangers comprises a first plurality of spray ports on a first side and a second plurality of spray ports on a second side opposite to the first side.

9. The system of claim 8, wherein each of the plurality of heat exchangers comprises a heat exchanger inlet region fluidly coupled to a plurality of heat exchanger passages shaped via a plurality of ribs, wherein each of the plurality of heat exchanger passages is fluidly coupled to a spray port of one or more of the first plurality of spray ports and the second plurality of spray ports.

10. The system of claim 9, wherein a height of the plurality of heat exchanger passages is non-uniform.

11. The system of claim 9, wherein one or more of the plurality of heat exchangers comprises only the first plurality of spray ports or only the second plurality of spray ports.

12. The system of claim 8, wherein the plurality of heat exchangers is parallel to the plurality of battery cells.

13. The system of claim 8, wherein the first plurality of spray ports and the second plurality of spray ports are positioned vertically above the plurality of battery cells.

14. The system of claim 8, wherein the thermal management system is an immersion thermal management system.

15. The system of claim 8, further comprising an inlet manifold configured to flow fluid into an interior volume of the housing and a conduit is configured to flow fluid out of the interior volume.

16. A battery system, comprising:
a plurality of battery cells arranged within a housing;
a plurality of bus bars mounted to a wall of the housing;
a plurality of lead lines coupled to the plurality of battery cells and the plurality of bus bars; and
a plurality of heat exchangers arranged with the housing, the plurality of heat exchangers comprising a plurality of spray ports configured to spray fluid onto the plurality of battery cells.

17. The battery system of claim 16, wherein each of the plurality of battery cells is in face-sharing contact along at least a face of a battery cell with a heat exchanger of the plurality of heat exchangers.

18. The battery system of claim 16, wherein a height of each of the plurality of heat exchangers is greater than a height of sides of the housing, and wherein the plurality of spray ports is positioned vertically above the plurality of battery cells.

19. The battery system of claim 16, further comprising an inlet manifold comprising a conduit fluidly coupled to a plurality of passages, each of the plurality of passages fluidly coupled to a heat exchanger inlet region of each of the plurality of heat exchangers, each of the plurality of heat exchangers comprising a plurality of ribs and a plurality of heat exchanger passages extending from the heat exchanger inlet region to the plurality of spray ports.

20. The battery system of claim 16, wherein two or more of the plurality of heat exchangers are sandwiched by two of the plurality of battery cells.
